(19) United States
(12) Patent Application Publication
(10) Pub. No.: US 2005/0089149 A1
(43) Pub. Date: Apr. 28, 2005

(54) Selectable voicemail greetings

(75) Inventor: Eran Elias, Even Yehuda (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 10/692,850

(22) Filed: Oct. 27, 2003

(51) Int. Cl. H04M 1/64; H04M 11/00

(52) U.S. Cl. 379/88.13; 379/88.16

(57) ABSTRACT

A user client for a communication device having several possible states and associated with a remotely located voicemail system. The user client includes a communication module for communicating with the remotely located voicemail system according to a current state of the communication device so as to enable selection of a greeting for output as a voicemail reply from the remotely located voicemail system to a calling party according to the current state. One of the states is a real time recording state, which allows a user to delay forwarding the call to the voicemail system to record a real time greeting for immediate use.

### FIELD AND BACKGROUND OF THE INVENTION

The present invention relates to selectable greetings for voicemail. Generally a voicemail service includes a message or a greeting which typically informs a caller that he has reached the voicemail of a given subscriber and invites him to leave a message after the tone. Typically the voicemail message is customizable so that a user can leave his own personalized greeting.

Besides customizable voicemail messages, different predetermined selectable telephone answering greetings are currently available. Certain mail box services and mobile telephones are able to identify the caller line identification (CLI) of an incoming call and select a corresponding predetermined greeting based on the identified CLI for use in an automated reply. Thus a given user is able to predetermine select greetings for given callers. A user may thus have a predetermined greeting for identified business acquaintances and another predetermined greeting for friends or family, in each case the particular greeting is selected by the identified CLI. The CLI information is generally made available to the voicemail system when an incoming call is forwarded thereto, and thus can be used to select the particular predetermined voicemail greeting. Such a mailbox service is described in “Multiple Greetings” A Product Description, dated May 2002 by Comverse Inc., 100 Quannapowitt Parkway Wakefield, Mass. 01880, the contents of which are hereby incorporated by reference herein.

In general, when a user receives a call which he decides he does not want to answer, his options are somewhat limited. He can wait without answering until the conclusion of a predetermined delay, so that the call is automatically transferred to the voicemail, or he can press the reject key and cause an immediate transfer. In general, there is no possibility of the user intervening to control the operation of the voicemail greeting. In addition, no mechanism is currently known that allows the voicemail to be controlled so as to provide specific information to the caller. For example the called party may wish the caller to understand that he cannot answer the telephone because he is presently in a meeting.

### SUMMARY OF THE INVENTION

The present invention overcomes the shortcomings attendant with the prior voicemail systems. According to one aspect of the present invention there is provided a user client for a communication device. The user client is able to assume a plurality of different states, the states being modes, settings, menu selections or the like made by the user at the communication device. The communication device is associated with a remotely located media-based network service such as a voicemail system, and the user client comprises a communication module for operating the communication device to communicate to the remotely located network service an indication of the present state of the communication device. It is therefore possible to enable control of the media-based network service according to the currently assumed state set by the user at the communication device.

Implementation of the present invention involves performing or completing selected tasks or stages manually, automatically, or a combination thereof. Moreover, according to actual instrumentation and equipment of preferred embodiments of the method and system of the present invention, selected stages could be implemented by hardware and/or by software on an operating system of firmware or a combination thereof within mobile telephones or on servers associated with mobile telephone networks or in any other electronic equipment. For example, as hardware, selected stages of the invention could be implemented as a chip or a circuit. As software, selected stages of the invention could be implemented as a plurality of software instructions that are executed by a computer using a suitable operating system. In any case, selected stages of the method and system of the invention could be performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be a useful and readily understandable description of the invention.

FIG. 1 is a block diagram illustrating an interactive connection between a handset and a voicemail system, according to a first preferred embodiment of the present invention FIG. 2 illustrates the embodiment of FIG. 1 in greater detail,

FIG. 3 is a screen display illustrating a menu for configuring a mode on a handset and showing that the mode settings include a selectable voicemail greeting,

FIG. 4 is a diagram illustrating successive runtime stages in placing a call to a user who has a handset mode set with a predetermined voicemail greeting,

FIG. 5 shows two screen displays for recording a greeting at a user handset,

FIG. 6 is a screen display illustrating a pop-up menu that appears in accordance with a preferred embodiment of the present invention, allowing a user to reject an incoming call and to select from a list of possible voicemail greetings,

FIG. 7 is a schematic diagram illustrating successive runtime stages in rejecting a call and selecting from a list of possible voicemail greetings according to the embodiment of FIG. 7, and

FIG. 8 is a diagram illustrating successive runtime stages of real time recording of a voicemail greeting according to a further embodiment of the present invention.

### DESCRIPTION OF THE PREFERRED EMBODIMENTS

Currently there is generally no interaction between handset modes or states (or any other handset activity) and a voicemail system. The voicemail system is usually located remotely from the handset, and only preset information such as the CLI can be used in voicemail greeting selection. The present embodiments utilize open operating systems known in the art such as Symbian and Java, provided in the user's handset to provide an interaction path between the handset and the voicemail system. This interaction path allows handset states, including current user input parameters, to be taken into account at the voicemail service. The open operating system Symbian is described, for example, at http:/www.symbian.com and at http://www.symbian.com/books/index.html, the contents of these websites are incorporated herein by reference. The open operating system Java is described for example at Java-www.iava.com and at http:H/www.java.com/en/learn/mobile.jsp. The contents of both of the above websites are hereby incorporated by reference herein.

The present embodiments disclose the selection of a greeting, such as a voicemail greeting, based on factors or data available to the local handset beyond a mere comparison of the CLI with a table or list of different predetermined voicemail greetings. In particular the selection of a voicemail greeting to be played to a calling party may be based on a user customizable mode that can be set at the user's handset. In addition, the handset according to the present embodiment allows active user selection from a menu of preset greetings at the time of receipt of the incoming call rather than a predetermined fixed selection. Thus the user may first view the calling CLI on his handset's screen and then actively select an appropriate voicemail greeting from a menu based on how the user wishes to respond to the caller identified by the displayed CLI. This embodiment thus provides a method of active call screening. In an alternative preferred embodiment, the user is able to make use of the time interval prior to forwarding of the call to the voicemail to record a new greeting for the calling party. The newly recorded greeting is recorded during the time interval and forwarded to the voicemail in real time and played back to the caller as the voicemail greeting.

The principles and operation of a voicemail greeting customization system according to the present invention may be better understood with reference to the drawings and accompanying description.

Before explaining the different embodiments of the invention in detail, it is to be understood that the invention is not limited in its application to the details of construction and the arrangement of the components set forth in the following description or illustrated in the drawings. The invention is capable of other embodiments or of being practiced or carried out in various ways as those skilled in the art will recognize.

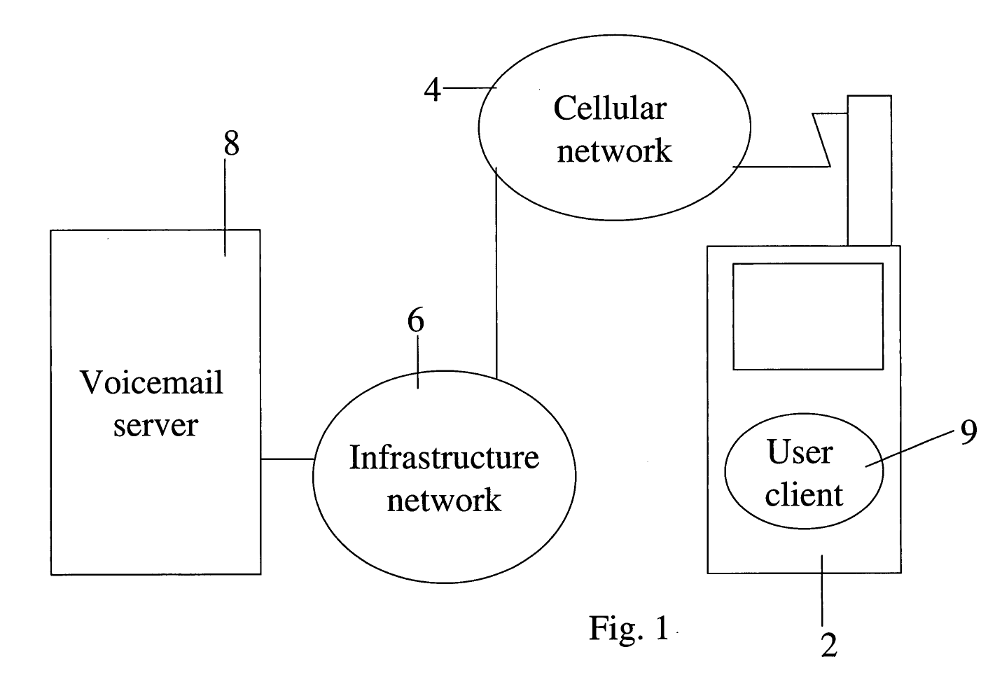

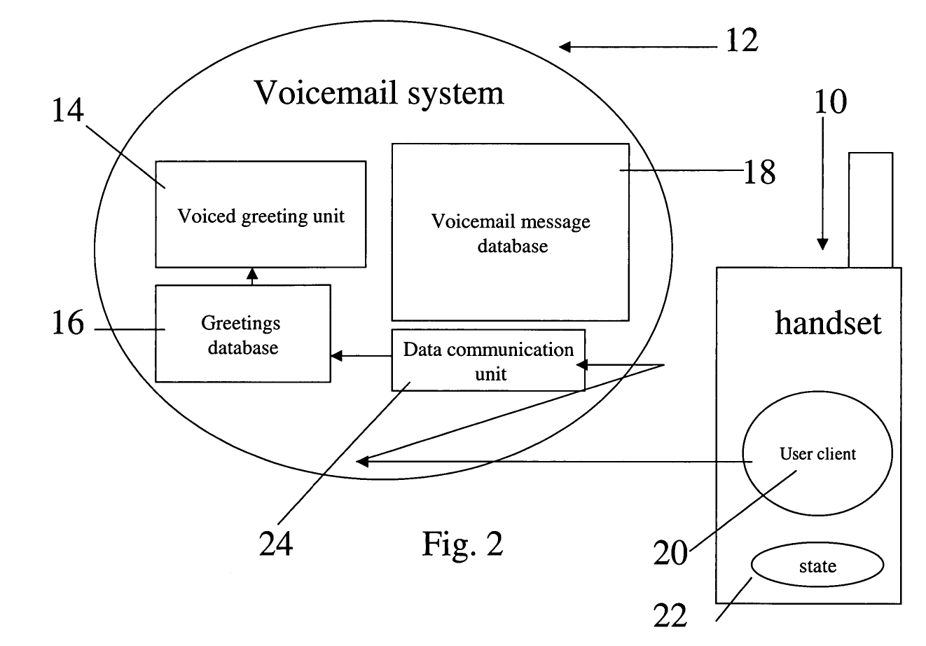

Reference is now made to FIG. 1, which is a schematic diagram illustrating the basic infrastructure on which preferred embodiments of the present invention may be supported. A voicemail greeting customization system comprises a cellular telephone 2 which is connected via the cellular network 4 and telephony infrastructure 6 to voicemail server 8. The connection over the cellular infrastructure supports both data and voice and allows the current state of telephone handset 2 to control operation of the voicemail system supported on server 8. The handset 2 can operate in various modes or stages that can be set on the handset and current user input states. User client 9 located on cellular telephone 8 is adapted as will be described in detail below to provide a user interface. The user client is a module, typically software but which can also be implemented as hardware or firmware, that provides local interfacing for remotely based features or services. The ability to communicate using data and voice allows the user to record voicemail greetings at the handset 2 and upload the recorded greetings to the voicemail server 8 together with codes or labels to indicate to the server how or when the greeting is to be used. As the greetings are all labeled in this way, a plurality of labeled greetings can be sent to the server. Then, later on, data instructions can be sent from the cellular telephone, using the labels or codes, as part of a current state of the cellular telephone, to indicate to the voicemail system which of the greetings to use when an unanswered call is forwarded to the voicemail system.

Reference is now made to FIG. 2, which is a simplified block diagram showing in greater detail the conventional infrastructure of FIG. 1 as used to support embodiments of the present invention. Mobile handset 10 is associated with voicemail system 12, so that when a call to mobile handset 10 is not completed it is automatically forwarded to voicemail system 12 in a conventional manner. voicemail system 12 comprises a voiced greeting unit 14 for playing greetings to callers, a greeting database 16 for storing personalized greetings, and a message database 18 for storing messages left by callers. Those skilled in the art will appreciate that in practice the voicemail system 12 employs an application layer which commands output ports to play the greetings as they are selected. The present embodiment particularly concerns the way in which the greetings are selected at the application layer. The above cited Multiple Greetings Product Description explains one way in which different greetings can be selected in accordance with the incoming CLI and the present embodiments extend the methodology disclosed therein to selection of greetings based on currently held mode information from the handset or based on real time input from the handset.

When a call is forwarded to the voicemail system 12, voiced greeting unit 14 plays a voiced greeting to the calling party. The voiced greeting is selected from greeting database 16. After playing the greeting, the calling party is given the opportunity to record a message for the unavailable called party, which is then stored in message database 18. Conventional voicemail systems usually provide a single voicemail greeting per user, and selection of the required greeting is simply a matter of matching the greeting to the correct user, typically performed by matching using the CLI of the user. In another known voicemail system, the system includes a plurality of greetings per party, and after finding the CLI of the called party, a further table is consulted to select the greeting. The table comprises preset CLIs for which the user has designated specific greetings. Again, further details of this voicemail system are available in the above cited Multiple Greetings Comverse product description.

Returning to FIG. 2, the handset 10 comprises a user client 20, which manages functions of the handset The handset enters a state or mode 22 either manually or automatically, as will be described below, and the mode, or other information identifying the mode, is communicated to communication unit 24 at the voicemail system 10. The voicemail system 12 uses the mode identifying information communicated by the user client 20 to select a greeting from the greeting database 16. For example, the mode identifying information communicated to the data communication unit 24 can be used as an address to select a greeting stored in greetings database 16. Those skilled in the art will recognize that communication of the mode identifying information from the mobile handset 10 to the voicemail system 12 may be carried out in a number of different ways. One way is to use the SMS (Short Messaging Service) capability typically available to the user client 20 and the carrier network. Another way is to employ USSD (Unstructured Supplementary Service Data). As those skilled in the art will understand, USSD is part of the GSM standard and is intended for exchanging data strings between mobile handsets and applications. GSM handsets are capable of supporting USSD, and USSD is currently used with such applications as chat and prepaid roaming. More information about USSD is available at http://www.mobilein.com/ussd.htm, the contents of which are hereby incorporated by reference. USSD is intended to be used independently within a GSM network to communicate the mode identifying information to the voicemail system 12 Three principal embodiments of the present invention will now be described. In one embodiment a data message, such as an SMS message or a USSD string is sent to the voicemail system 12 whenever the handset changes modes. In this embodiment, the SMS message or USSD data string contains information identifying the new handset mode. In another embodiment, a user selects a pre-recorded greeting from a menu upon receipt of a call, and the selected greeting is played to the calling party as a voicemail greeting. Again USSD or SMS may be used to communicate the user-selected greeting to the voicemail system. In a third embodiment the user actually records a greeting in real time upon receipt of an incoming call. The recorded greeting is then forwarded to the voicemail system and the newly recording greeting is used as the voicemail greeting for the currently incoming call. In this third embodiment the ‘voice over IP’ capability is the preferred method of communicating the greeting, and protocols such as Push-to-Talk, which support voice over IP, are used.

It is noted that the above discussion describe voicemail greetings. However the invention is in no way so limited. For example, videomail systems may be used with the present embodiments in which a video greeting is played to a calling party. The present embodiments work in exactly the same way with video greetings except that in the third embodiment, a ‘video over IP’ capability is necessary and an equivalent protocol called Push-to-Show is used instead of the Push-To-Talk protocol.

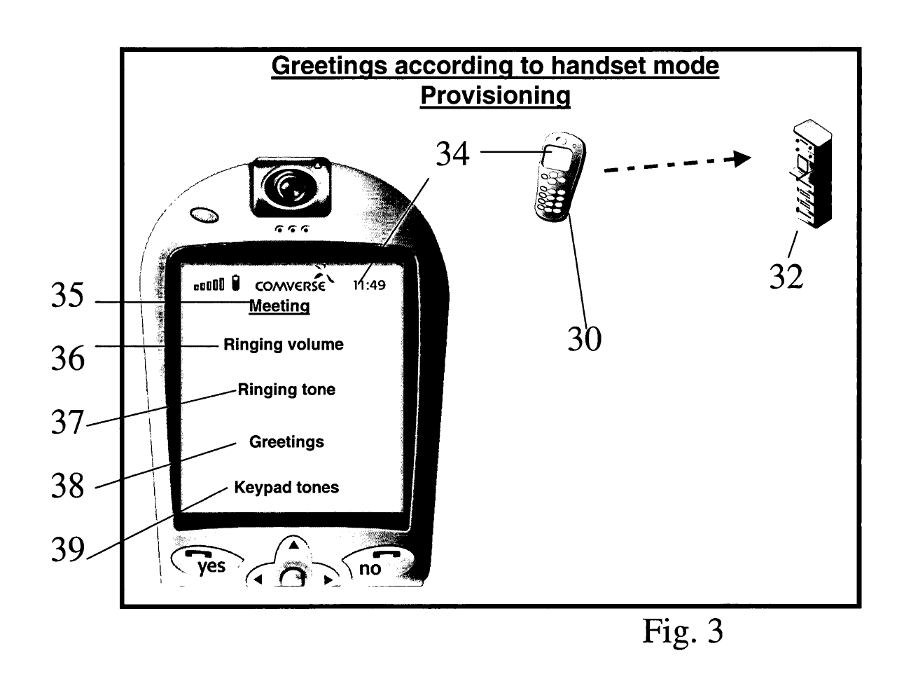

Reference is now made to FIG. 3, which is a diagram illustrating a mode definition sub-menu for a user defined mode in an embodiment of the present invention in which the recorded greeting is selected according to the current mode of the handset. In FIG. 3, a handset 30 displays a mode definition menu for a mode called “meeting” 35. Screen 34 of handset 30 illustrates a number of settings available for defining the mode “meeting”. The menu allows the user to assign to the meeting mode, a specific ringing volume 36, ringing tone 37, keypad tone 39 and voicemail greeting 38.

Software support within the handset allows a number of such modes to be defined, each with its own settings, including its own greeting. Then, as the handset changes to a new mode, the voicemail system receives the information identifying the new mode, and is instructed to select the predetermined greeting for that mode. The change of modes may either be at the user's instruction or may be automatic so that the greeting associated with the present mode is selected. An example of an automatic mode is a busy mode, which the handset enters automatically when engaged on another call. The handset simply notifies the voicemail system when it begins a call and the voicemail system reacts in the same way as with other modes by setting the relevant greeting. According to the mode definition embodiment, a user can associate each mode with a specific greeting to indicate to callers what the user is doing, without it being necessary for him to answer the call. For example, the user may define a “busy” mode, a “meeting” mode (shown), a “sleep” mode, an “out to lunch” mode and the like, all being different kinds of activities which may explain to a caller why the call is not being answered. The definition of such modes is supported by legacy handsets via the SIM toolkit application. Details of the SIM toolkit may be found at http://www.cellular.co.za/sim_toolkit.htm the contents of which are hereby incorporated by reference. The SIM toolkit allows a programmer to set modes, provide a menu system for allowing a user to define his own modes and allows a programmer to define messages for sending to various addresses upon changes of those modes. In handsets equipped with smart operating systems it is possible simply to download the application to the handset, the handset in effect being a smart client. Many of the latest mobile handsets on sale have such smart operating systems, and a specific example is Nokia 7650 sold by Nokia of Finland, which has a Symbian operating system and which also supports Java. Further details may by found at http://www.nokia.com/nokia/0,8764,815,00.html the contents of which are hereby incorporated by reference. The modes of the handset may include automatic modes, such as a mode for being engaged on another call, as described above, as well as manual modes which require active selection by a user.

Once a particular mode is defined, the handset informs the voicemail system of the change in mode, and hence the change in greeting, by means of a USSD string, or an SMS message. The mode can be changed by the user selecting an item from a mode selection menu on the handset 10. The mode menu can be located in a profile section of the handset menu system. Preferably the user is able to define and name his own modes as he sees fit. Thus, the user may often be unable to answer calls because he is involved in meetings. He may thus wish to define a mode in which a special announcement is made indicating that he is unable to answer because he is in a meeting. The user thus chooses a mode definition menu item. He provides a label for the mode, such as “meeting” item 35 in FIG. 3, and he is then able to provide various settings for the mode, including an appropriate greeting, via the sub-menu that appears under the heading “meeting”. As discussed above, the definition of a mode can include assigning such settings as a specific ring tone, ring volume, keypad tones, message alert tone (not shown in the menu illustrated) and voicemail greeting. Subsequently, when the handset is activated in the given mode, all of the settings for that mode become operational selections of the handset. Specifically, once the mode is defined, the SIM toolkit, which is included as part of the software package in the handset 10, generates a USSD string or an SMS message that is forwarded to the voicemail system 12, so that the voicemail system 12 is informed of the new state or mode of the handset. The message includes at least a label indicating the identity of the current mode, and may further include parameters of the mode to the extent that the parameters relate to features that are operated from the voicemail system. The data may be transmitted in other ways, but the above described ways are presently preferred as they are readily available on the cellular infrastructure. As long as the voicemail greeting is pre-recorded, (i.e., not recorded in realtime), it is possible to use regular call placement procedures from the handset to select the greeting. A session initiator protocol (SIP)-which is a session initiator for voice over IP—is able to support the communication requirements of the present embodiment. That is, USSD is sufficient when simply informing the voicemail system 12 about a change in mode made by the user at the handset 10. However, the embodiment discussed below is intended to allow the user to record his own customized greetings for the various modes. Sending customized voiced greetings to the voicemail system cannot be achieved merely by sending data via a USSD string or SMS message, since they lack a voice channel. Moreover, a standard voice channel is not ideal for this embodiment since it is preferable to communicate control information needed by the voicemail system 12 to select the appropriate mode or state together with voice information. Such control information may typically be flag or identifier type information, able to indicate which mode the greeting belongs to. Thus preferably a combined voice and data channel is required. Such a combined channel may be provided, for example, using the push-to-talk protocol. Push-to-talk protocol is not a universally defined protocol and is implemented in different ways by different vendors but in general supports Voice over IP, which is to say it supports the sending of voice packets over the IP infrastructure. The publication “Next Generation Push to Connect Provides Simple User Interface for Instant Communication—The Yankee Group Report—Wireless Mobile Technologies, X. J. Wang and Philip Marshal, August 2003” the contents of which are hereby incorporated by reference, provides a review of the “push to connect” technology and market. Nextel (www.nextel.com) and a number of other companies have proprietary versions of the technology The packets in this protocol may include both the voice itself and also control data, and thus the protocol can be used to communicate the necessary data to the voicemail system 12 so that the voicemail system 12 can select the appropriate greeting. That is, the control data included with the voice packets may include the information necessary to identify the voicemail system which mode the present voice greeting is intended for. As a further example, the voice packets may include a voicemail greeting recorded in real time by the user, along with data packets including information indicating that the voicemail system 12 should be switched to a particular mode, such as the meeting mode.

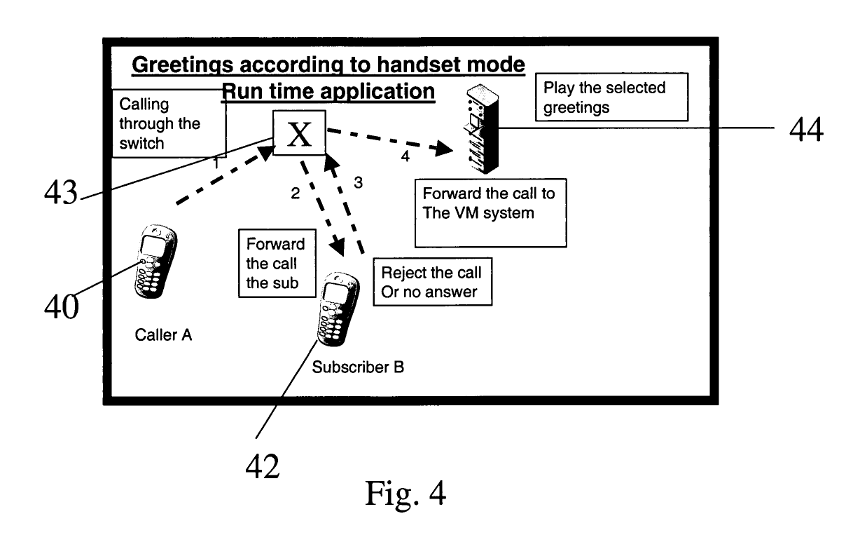

Reference is now made to FIG. 4, which is a diagram illustrating successive stages in runtime operation of the embodiment of FIG. 3. In an initial stage, a subscriber sets his handset 10 to one of the modes he has predefined. Then, in FIG. 4, caller A 40 calls the called party B 42 via a switch or exchange 43. The call is forwarded from the switch to called party B 42 who for some reason does not answer the call or who actively rejects the call. The call is thereafter forwarded to the voicemail system or server 44 in the conventional manner. In this example, voicemail system 44 already knows the handset mode of called party 42 since it was informed at the last change of mode by the user. The voicemail system 44 selects the greeting provided for the given mode and plays the greeting to the calling party 40. For example, the meeting mode may have been selected by the user at the last mode change. After the user selects the meeting mode, information identifying the meeting mode is communicated to the voicemail system so it knows to select a greeting corresponding to the meeting mode. The calling party 40 would therefore receive a voicemail greeting indicating that the called party 42 is presently in a meeting.

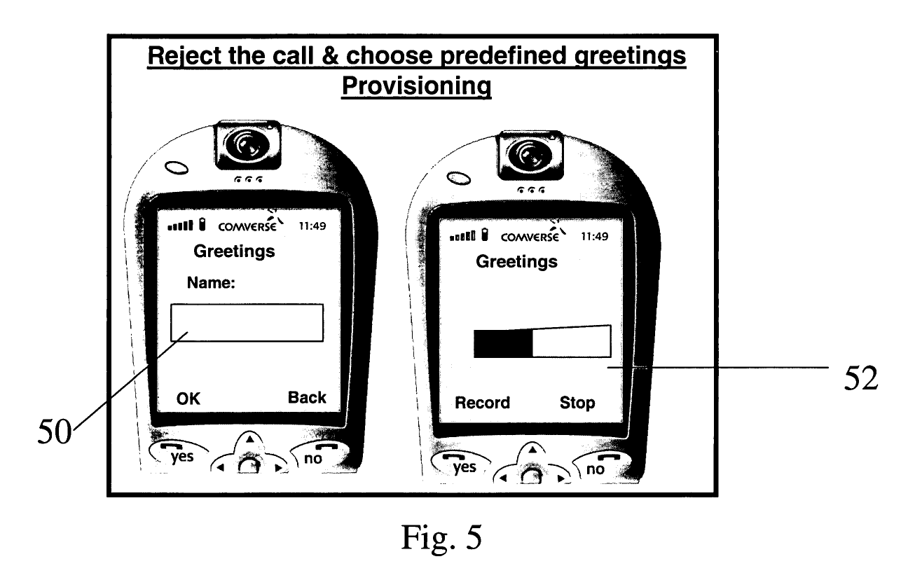

Reference is now made to FIG. 5, which is a diagram illustrating two screen displays for another embodiment of the present invention, in which the user pre-records a plurality of different greetings and then actively selects between them when rejecting a call. Standard handsets and even the simplest wireline terminals support recording of a single greeting according to instructions provided from the voicemail system, using DTMF for user interaction. The present embodiment makes use of a client application, for example the SIM toolkit application, to allow for recording of a plurality of different greetings for later selection by the user. The embodiment provides the additional feature that the user handset also attaches a unique identity to each greeting so that the greeting may be selected from a menu of greetings. The handset supports incorporation of the identity of the greeting, in the form of a label, into the menu, from which to select the greeting. In FIG. 5, screen 50 allows a user to enter a label for a particular greeting, and screen 52 is a screen that appears during recording of the greeting, to allow the user to indicate starting and stopping of the recording.

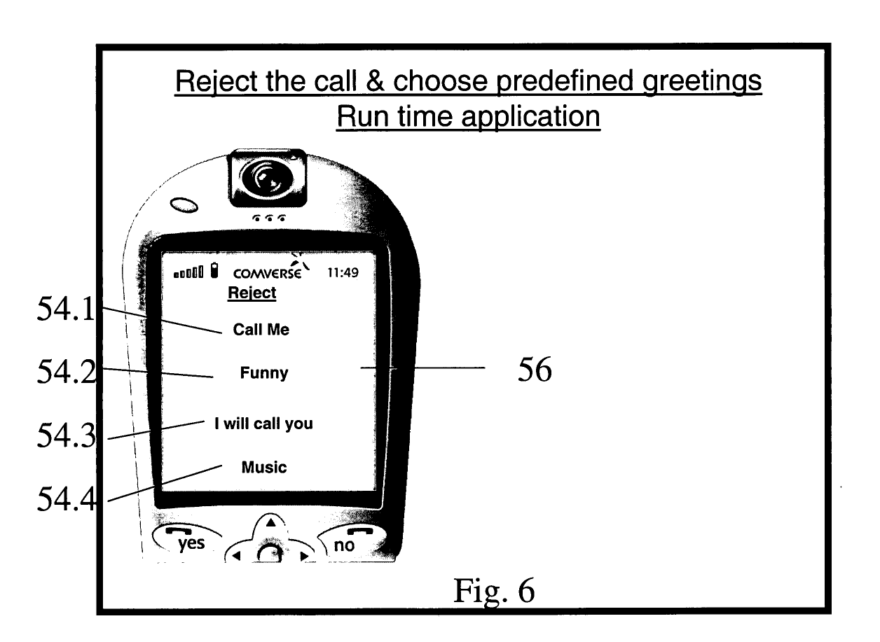

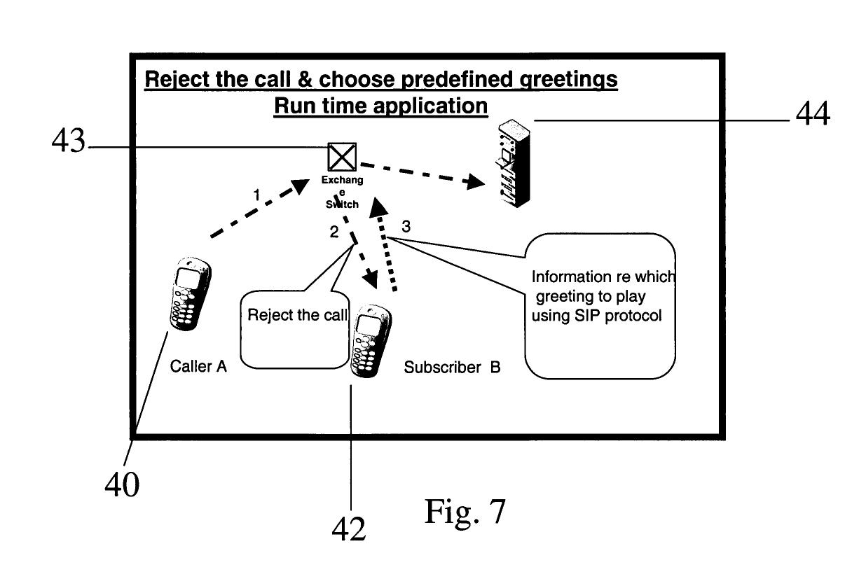

In use the user decides that he needs a greeting to indicate that he is unable to answer because he is involved in a meeting. He therefore selects a menu item for recording of a new greeting and obtains screen 50. He enters the label “meeting” and then moves on to screen 52 in which he records a suitable greeting. Subsequently, when the user receives a call and wishes to reject it for whatever reason he selects a menu item called “reject” and then he is given a sub-menu with a list of pre-recorded greetings. In the sub-menu may appear the label “meeting” he defined in screen 50, which he can select. The selection plays the message recorded in screen 52 so that the caller is told that the called party is in a meeting. Reference is now made to FIG. 6, which is a diagram illustrating a screen that appears when rejecting a call, in accordance with the embodiment of FIG. 5. A number of greetings have been recorded in accordance with the procedure outlined in FIG. 5 and each of these greetings appears with its corresponding label defined in screen 50 as a menu item 54.1 . . . 54.4 on a menu 56. Menu 56 appears on the screen automatically when receiving an incoming call, or in an alternative embodiment may be selected when actively rejecting a call. When menu 56 appears, the user simply selects the menu item corresponding to the greeting he wants the caller to hear, as described above. Thus, in the present case the user is able to select between a message entitled “call me”, a message entitled “funny”, a message entitled “I will call you” and a message entitled “music”. The selection is preferably communicated to the voicemail system using the SIP protocol (session initiator protocol). An alternative communication path lies in using messaging and data strings, as outlined in the previous embodiments, however in practice messaging systems such as SMS do not guarantee immediate delivery and thus are liable to be too slow to alert the voicemail system in time to play the greeting. Reference is now made to FIG. 7, which is a diagram illustrating a runtime procedure for using the embodiment of FIG. 5 upon receipt of an incoming call. Parts that are the same as in previous figures are given the same reference numerals and are not referred to again except as necessary for understanding the present embodiment. Calling party A 40 places a call to called party B 42 via an exchange switch 43. The call is forwarded to called party B 42 who is informed of the identity of the calling party A 40 via the handset display of the CLI. The called party B 42 chooses to reject the call. In rejecting the call he selects a menu item corresponding to a greeting he feels is appropriate, such as “I will call you”, and information identifying the choice of greeting is forwarded with the rejected call to server 44 supporting the voicemail system. Forwarding of the greeting choice information is preferably made using the SIP protocol. The selected greeting is then played to the calling party 40 from the voicemail system.

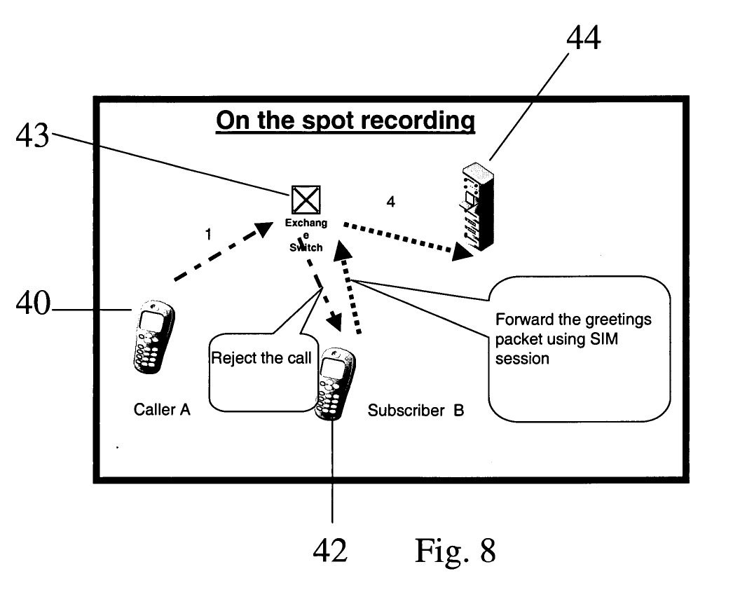

Reference is now made to FIG. 8, which is a diagram illustrating a simplified runtime procedure upon receipt of an incoming call in another embodiment of the present invention. In the embodiment of FIG. 8, real time recording of a greeting is carried out by the user upon receipt of an incoming call. Parts that are the same as in previous figures are given the same reference numerals and are not referred to again except as necessary for understanding the present embodiment. As the skilled person will be aware, unless a call is actively rejected, a certain time interval, typically about six seconds, is available for the telephone to ring prior to the call being forwarded to the voicemail system. In the present embodiment the user is able to make use of this time interval to record a customized greeting for the calling party. It is also possible to introduce additional time into the delay, provided that the caller is not induced to hang up. Thus opening the recording option may delay forwarding of the call to the voicemail so the user has more than six seconds to record a message. As shown in FIG. 8, a call is received, via switch 43, from calling party 40 and causes the handset of called party 42 to ring. The called party notes the CLI of the calling party from his screen, decides that he wishes to reject the call and selects a menu item for recording a greeting. He then records a greeting during the time interval available. A push-to-talk protocol session may then be used to forward the newly recorded greeting in real time to the voicemail system 44. “Push-to-talk” is a generic name for a protocol that manages voice and data together in real time. There is currently no standardized version of the protocol and each vendor uses his own version, however next generation systems define an RTP or real time protocol, as part of their IMS, which is a standardized protocol for carrying out such functions. The embodiment shown in FIG. 8 can be implemented with a particular vendor push-to-talk protocol or the real time protocol.

At the end of the time delay the call is forwarded to the voicemail system 44 and the recorded greeting is played as the voicemail greeting for the calling party to hear. Alternatively the voicemail system may wait beyond the predetermined delay for the recording to be completed. Thus the user is able to provide the caller with a personalized greeting, without having to answer the call.

It is appreciated that certain features of the invention, which are, for clarity, described in the context of separate embodiments, may also be provided in combination in a single embodiment. Conversely, various features of the invention, which are described in the context of a single embodiment, may also be provided separately or in any suitable subcombination.

In addition, citation or identification of any reference in this application shall not be construed as an admission that such reference is available as prior art to the present invention.

Amongst the claims that follow are a series of claims to a user client and a series of claims to a device supporting a user client. The user client is defined inter alia in terms of adaptations for the purpose of interaction with remotely located services over a network. However it is not intended by these claims to suggest that the remotely located services are a constituent part of the user client.

1. A user client for a communication device, said user client being able to assume a number of different states, said communication device operable to communicate with a remotely located media based network service, the user client comprising: a communication module for causing said communication device to communicate information representing a currently assumed one of said states to a remotely located network system so as to enable control thereof according to said currently assumed state.

2. The user client of claim 1, further comprising said remotely located network system, wherein said remotely located network system is in communication with said user client, and wherein said remotely located media based network service comprises a voicemail system.

3. The user client of claim 1, further comprising said remotely located network system, wherein said remotely located network system is in communication with said user client, and wherein said remotely located media based network service comprises a video based system.

4. The user client of claim 2, wherein a plurality of prerecorded greetings are available for interoperation with said user client at said remotely located network and wherein control of said remotely located media based network comprises selection of one of said greetings in accordance with the currently assumed state, and said control further comprising causing the selected greeting to be played back as a voicemail reply from said remotely located voicemail system to a calling party.

5. The user client of claim 4, wherein said communication module comprises a data messaging protocol.

6. The user client of claim 4, further comprising a module for presenting to a user, upon receipt of an incoming call, an ability to select one of said different states instead of answering said call.

7. The user client of claim 6, wherein said communication module is configurable according to a selected one of said states to communicate said selected state to the voicemail system so as to cause said voicemail to select a greeting corresponding to the selected state.

8. The user client of claim 6, wherein said module is configured such that said communication device is operable to present a plurality of different greetings for user selection therefrom, each state being associated with a different one of said greetings.

9. The user client of claim 4, wherein said user client is switchable substantially at any time between said states, and wherein said communication module is configured to communicate to said voicemail system an exchange of states so as to enable said voicemail system to select a voicemail greeting according to said current state.

10. The user client of claim 4, further comprising a user input for allowing a user to define at least one of said states and to associate a different greeting with each of said states.

11. The user client of claim 10, further comprising a user input for allowing a user to record a greeting for association with one of said states.

12. The user client of claim 4, wherein one of said states is a real time recording mode enterable upon receipt of a call at said communication device, said user client further comprising a user interface for enabling a user to record in real time a new greeting upon receipt of said call.

13. The user client of claim 12, wherein said real time recording mode is configured so as to carry out said recording of the new greeting whilst delaying forwarding of said call from said communication device to said voicemail system.

14. The user client of claim 12, wherein said real time recording mode is configured to forward said recorded greeting as at least one voice packet to said voicemail system for playing as said reply.

15. The user client of claim 14, wherein said communication module is configured to communicate said voicemail greeting, together with control data for said voicemail system, using voice packets.

16. The user client of claim 4, further comprising a user interface for allowing a user to select between
(1) a menu of predefined voicemail greetings; and
(2) recording a new voicemail greeting.

17. The user client of claim 4, wherein said communication device is a mobile communication device.

18. A communication device comprising a user client, said user client being operable to configure said communication device into any one of a plurality of states and further to configure said communication device for communication with a remotely located voicemail system so as to apply settings to said voicemail system.

19. The communication device of claim 18, wherein said applying settings comprises selection of a voicemail reply greeting by said remotely located voicemail system in accordance with a current state of said communication device.

20. The communication device of claim 18, further comprising a data messaging module for communicating with said remotely located voicemail system.

21. The communication device of claim 19, further comprising a communication module configured to communicate to said remote voicemail system any change in state at said communication device so as to control said voicemail system to provide a voicemail greeting according to said current state.

22. The communication device of claim 19, wherein said user client is configured into one of said plurality of states by the user selecting a predefined greeting from a menu of predefined greetings at said communication device.

23. The communication device of claim 19, wherein said user client is configured into one of said plurality of states by the user selecting between (1) a menu of predefined greetings and (2) recording of a new greeting.

24. The communication device of claim 19, wherein one of said states is a real time recording state enterable upon receiving a call from a caller, and wherein said real time state permits a user to record a greeting in real time and to send said recorded greeting to said voicemail system for playback as the voicemail greeting to said caller.

25. The communication device of claim 24, wherein the device is operable to record the greeting in real time whilst delaying forwarding of said call from said communication device to said voicemail system.

26. The communication device of claim 24, wherein the device is operable to forward said recorded greeting as at least one voice packet, together with control data, to said voicemail system for playback as the voicemail reply.

27. The communication device of claim 18, wherein the communication device is a mobile communication device.

28. The communication device of claim 21, wherein said plurality of possible states comprises at least one user definable mode, said user client comprising a user interface for defining of said user definable mode.

29. The communication device of claim 21, wherein said plurality of possible states comprises at least one user selectable mode, said user client comprising a user interface for user selecting of said mode.

30. A server-based subscriber service system comprising:
an output unit for outputting selected content, and
a content selection unit, associated with said media output unit for using data representing a current state of a called party handset to select said content for output by said output unit.

31. The server-based subscriber service system of claim 30, wherein said media content is a voicemail greeting.

32. The server-based subscriber service system of claim 30, further comprising a data communication unit associated with said content selection unit for receiving state data from said called party handset from which to determine said current state.

33. The server-based subscriber service system of claim 30, wherein said current state is a real time record state, and further comprising a module operable to receive a real time recorded item for immediate output as said selected item.

34. The server-based subscriber service system of claim 32, wherein said communication unit is operable to receive said state data in at least one of SMS format and USSD format.

35. The server-based subscriber service system of claim 32, wherein said data communication unit is operable to use the push-to-talk protocol to enable receipt of said content together with said state data.

36. The server-based subscriber service of claim 32, wherein said content is video, and said communication unit is operable to use the Push-to-Show protocol to enable receipt of said video item.

37. A method of providing remote control to a server-based subscriber service comprising:
using a media channel to receive media content for use in said subscriber service,
using a data channel to receive data concerning said media content, and
using said received data to select, from said received media content, a content item for use in said subscriber service.

38. The method of claim 37, wherein said received data comprises data received with said media content and data received subsequent to said media content.

39. A handset and server based greeting system comprising:
a user handset, and
a server based greeting system located remotely from said handset over a communication network,
wherein said server based greeting system comprises:
a memory for storing a plurality of greetings associated with a given user handset and;
a selector for selecting one of said greetings as a current greeting for playing to a rejected call forwarded from said handset; and wherein said handset comprises a message communication module for communicating to said server based greeting system an indicator for instructing said selector to select a given greeting as said current greeting.

40. The handset and server based greeting system of claim 39, wherein said message communication module is further configured to communicate to said server based greeting system an indicator to accept a greeting presently being recorded at said handset as said current message.

41. A handset and server based greeting system comprising:
a user handset, and a server based greeting system located remotely from said handset over a communication network, and wherein said server based greeting system comprises a memory for storing at least one greeting associated with a given user handset and wherein said handset comprises a message communication module for communicating to said server based greeting system:
1) a rejection of a current incoming call and
2) an indicator for instructing said selector to select a greeting presently being recorded at said handset as said current message, thereby to allow a realtime recorded greeting to be played as a voicemail greeting to said current incoming call.

42. A user client and server based greeting system comprising:
a user client for a user handset, and
s server based greeting system located remotely from said handset over a communication network,
wherein said server based greeting system comprises:
a memory for storing a plurality of greetings associated with a given user handset and;
a selector for selecting one of said greetings as a current greeting for playing to a rejected call forwarded from said handset;
and wherein said user client comprises a message communication module for communicating to said server based greeting system an indicator for instructing said selector to select a given greeting as said current greeting.

43. The user client and server based greeting system of claim 42, wherein said message communication module is further configured to communicate to said server based greeting system an indicator to accept a greeting presently being recorded at said handset as said current message.

44. A user client and server based greeting system comprising:
a user client for a user handset, and a server based greeting system located remotely from said handset over a communication network, and wherein said server based greeting system comprises a memory for storing at least one greeting associated with a given user handset and wherein said user client comprises a message communication module for communicating to said server based greeting system:
1) a rejection of a current incoming call and
2) an indicator for instructing said selector to select a greeting presently being recorded at said handset as said current message, thereby to allow a realtime recorded greeting to be played as a voicemail greeting to said current incoming call.
